(19) United States
(12) Patent Application Publication
(10) Pub. No.: US 2010/0207924 A1
(43) Pub. Date: Aug. 19, 2010

(54) APPARATUS FOR DRIVING ELECTROPHORETIC DISPLAY UNIT, ELECTROPHORETIC APPARATUS, ELECTRONIC DEVICE, AND METHOD OF DRIVING ELECTROPHORETIC DISPLAY UNIT

(75) Inventor: Hidetoshi Saito, Suwa-gun (JP)

Correspondence Address: ADVANTEDGE LAW GROUP, LLC, 922 W. BAXTER DRIVE, SUITE 100, SOUTH JORDAN, UT, 84095, US

(73) Assignee: Seiko Epson Corporation, Tokyo (JP)

(21) Appl. No.: 12/693,536

(22) Filed: Jan. 26, 2010

(30) Foreign Application Priority Data
Feb. 17, 2009 (JP) 2009-034097
Sep. 25, 2009 (JP) 2009-221215

(51) Int. Cl. G09G 5/00; G09G 3/34

(52) U.S. Cl. 345/211; 345/107

(57) ABSTRACT

An apparatus for driving an electrophoretic display unit includes: a current detector that detects a driving current supplied to or flowing out from the electrophoretic display unit and outputs a detection value corresponding to the driving current; a conversion unit that converts the detection value into a corresponding temperature equivalent value; and a driver that generates a driving control signal of the electrophoretic display unit based on the temperature equivalent value.

### BACKGROUND

1. Technical Field

The present invention relates to an apparatus for driving an electrophoretic display unit, and more particularly, to an apparatus for driving an electrophoretic display unit embedded in a small-sized portable device such as a wristwatch.

2. Related Art

An electrophoretic apparatus is a device for displaying images by controlling a voltage applied between electrodes to control the movement of electrically-charged particles and change the colors of the external appearance. Recently, applications are being researched and developed to embed the electrophoretic apparatus into a small-sized portable device such as a wristwatch. The movement of the electrically-charged particles within the electrophoretic apparatus is influenced by the viscosity of a solvent. Since the viscosity of the solvent is highly dependent on temperature, it is necessary to use a driving signal having an optimal driving voltage and waveform depending on the temperature. If the driving signal of the electrophoretic apparatus is inappropriate, the display contrast of the electrophoretic apparatus becomes deteriorated. For example, JP-T-2005-527001 discloses a method of measuring a solvent temperature using a temperature detector (i.e., temperature sensor) and controlling a potential difference between electrodes of the electrophoretic element depending on the measured solvent temperature.

In the electrophoretic apparatuses of the related art, in which a potential difference between the electrodes of the electrophoretic apparatus is controlled based on a solvent temperature measured using a temperature sensor, it is necessary to add a temperature sensor for measuring the solvent temperature to the electrophoretic apparatus.

However, since a small-sized electronic device such as a wristwatch is required to have a limited packaging volume, it is desirable to avoid mounting a relatively large component such as a temperature sensor.

### SUMMARY

An advantage of some aspects of the invention is to provide an apparatus or method of controlling the driving control signal applied to the electrodes of the electrophoretic element to have appropriate driving voltage and waveform based on a temperature equivalent value of the electrophoretic display unit without using the temperature sensor.

According to an aspect of the invention, there is provided an apparatus for driving an electrophoretic display unit including: a current detector that detects a driving current supplied to or flowing out from the electrophoretic display unit and outputs a detection value corresponding to the driving current; a conversion unit that converts the detection value into a corresponding temperature equivalent value; and a driver that generates a driving control signal of the electrophoretic display unit based on the temperature equivalent value.

According to another aspect of the invention, there is provided a method of driving an electrophoretic display unit, the method including: detecting a driving current supplied to or flowing out from the electrophoretic display unit and outputting a detection value corresponding to the driving current; converting the detection value into a corresponding temperature equivalent value; and generating a driving control signal of the electrophoretic display unit based on the temperature equivalent value.

In this case, a temperature equivalent value which changes depending on a solvent temperature is obtained, the driving control signal of the electrophoretic display unit is generated based on the temperature equivalent value, and a potential difference between the electrodes of the electrophoretic element is controlled without using a temperature sensor. As a result, since the temperature sensor becomes dispensable, it is possible to effectively use the limited volume of the apparatus. Since the temperature sensor is not used, it is possible to reduce the manufacturing cost. Particularly, if this configuration or method is applied to the semiconductor IC (integrated circuit), it would be advantageous from the viewpoint of volume efficiency as well as manufacturing cost.

When the solvent temperature is measured using a temperature sensor of the related art, the measured solvent temperature is sometimes different from the actual solvent temperature of the electrophoretic display unit depending on the location where the temperature sensor is located. For example, a small-sized electronic device such as a wristwatch often has a different temperature depending on the measurement location even within the wristwatch because a human body temperature measured at a surface making contact with human skin is significantly different from an external atmospheric temperature measured at a surface making contact with an external atmosphere in a cold winter season. In this case, since the small-sized electronic device such as a wristwatch is configured within a limited packaging volume, it may be impossible to dispose the temperature sensor near the solvent in the electrophoretic display unit, which is a desired location to measure temperature. Accordingly, the temperature sensor is inevitably disposed far from the electrophoretic display unit, and thus, the measurement temperature is often different from the actual temperature. Since the driving control signal of the electrophoretic display unit is generated based on the temperature measured by the temperature sensor, which is different from the actual solvent temperature, contrast of the electrophoretic display unit may be deteriorated.

In this case, a temperature equivalent value converted based on a detection value corresponding to the driving current supplied to or flowing out from the electrophoretic display unit is used to generate the driving control signal. The driving current of the driving control signal changes depending on the temperature of the electrophoretic display unit irrespective of the location of the current detector, and the temperature equivalent value corresponds to the driving current. Therefore, it is possible to generate an accurate driving control signal depending on the temperature of the electrophoretic display unit.

It is preferable that the driver includes: a driving voltage generator that generates a driving voltage by boosting a first voltage; and a driving control signal generator that generates the driving control signal having a predetermined pulse width, a predetermined number of pulses, and a predetermined voltage based on the driving voltage, wherein the driving control signal generator is configured to change at least one of the pulse width, the pulse number, and the voltage of the driving control signal.

It is preferable that the driver includes: a driving voltage generator that generates a driving voltage by boosting a first voltage using a frequency signal; and a driving control signal generator that generates the driving control signal having a predetermined pulse width, a predetermined number of pulses, and a predetermined voltage based on the driving voltage, wherein the frequency of the frequency signal can change depending on the temperature equivalent value.

It is preferable that the current detector includes: a detection resistor disposed between the driving voltage generator and the electrophoretic display unit; and a potential difference detector that detects a potential difference between both ends of the detection resistor and outputs, as a detection value, a driving current equivalent value based on a result of the detection.

In this case, instead of directly measuring the driving current, but a potential difference corresponding to the driving current of the electrophoretic display unit can be measured using the detection resistor and the potential difference detector. As a result, it is possible to inexpensively configure the current detector and the apparatus for driving the electrophoretic display unit having a simple configuration.

The current detector may include a detection resistor disposed between the electrophoretic display unit and a ground potential; and a potential difference detector that detects a potential difference between both ends of the detection resistor and outputs, as a detection value, a driving current equivalent value based on a result of the detection.

In a case where the detection resistor is disposed between the electrophoretic display unit and the ground potential as described above, it is possible to use a simple amplification circuit as the potential difference detector to simplify the configuration of the potential difference detector. In addition, it is possible to select more options regarding the circuit configuration.

It is preferable that the conversion unit includes: an A/D converter that converts the detection value from an analog value into a digital value; a cumulative average computing unit that outputs a cumulative average value obtained by adding and averaging the digital value for a time that is determined in advance; and a conversion computing unit that converts the cumulative average value into a corresponding temperature equivalent value.

In this case, since it is possible to operate using a detection value converted by the A/D converter into a digital value, the electrophoretic apparatus can be appropriately employed in digitally operable apparatuses. Further, it is possible to avoid increasing the number of analog components, which is easy to increase in size. As a result, it is possible to package the apparatus for driving the electrophoretic display unit within a limited packaging volume. Furthermore, it is possible to avoid increases in cost that may be caused by increasing the number of analog components.

It is preferable that the conversion computing unit converts the cumulative average value into the corresponding temperature equivalent value with reference to a lookup table which has been previously prepared.

In this case, it is possible to perform conversion into the temperature equivalent value from the cumulative average value based on a limited combination using a lookup table stored in a non-volatile storage unit such as flash memory. Therefore, it is possible to perform the conversion by a relatively simple processing using the conversion computing unit. Further, since the lookup table stored in flash memory or the like is used, a lookup table appropriate to a characteristic deviation in a manufacturing process may be stored depending on a characteristic of each product.

It is preferable that the apparatus for driving the electrophoretic display unit further includes a display signal generator that generates a display signal for displaying an image on the electrophoretic display unit, wherein the conversion unit converts the detection value while the electrophoretic display unit displays an image that is determined in advance.

In this case, since a timing for converting the detection value into the corresponding temperature equivalent value in the conversion unit is set to a period for displaying an image, which is determined in advance, on the electrophoretic display unit, deviation in the driving current caused by changing the display image is not generated. That is, the driving current changes even at the same temperature if the display image changes in each case. However, if the display image is determined in advance, the driving current will be the same at the same temperature. As a result, it is guaranteed that the current detector outputs the detection value in response to the driving current depending not on the display image but only on the temperature. By using the temperature equivalent value converted based on the detection value in response to the driving current independent of the display signal it is possible that the driving control signal generator generates the more appropriate driving control signal of the electrophoretic display unit.

Whether or not the display image is an image that is determined in advance may be determined with reference to information for rewriting display images, for example, from the display signal generator or the like which generates the display signal. In a case where information cannot be obtained from the display signal generator or the like, the conversion unit may observe the display signal to determine whether or not the display signal is to display the image that is determined in advance.

It is preferable that the conversion unit converts the detection value at an interval that is determined in advance based on change of the response speed of an electrophoretic display unit corresponding to change of an atmospheric temperature.

Although the electrophoretic display unit according to the invention is influenced by change of the temperature, the solvent temperature of the electrophoretic display unit smoothly changes in comparison with change of the atmospheric temperature even when the surrounding atmospheric temperature abruptly changes. In the first place, the surrounding atmospheric temperature seldom abruptly changes.

According to a characteristic of the invention, since the conversion unit converts the detection value at an interval that is determined in advance, based on change of the response speed of the electrophoretic display corresponding to change of an atmospheric temperature, it is possible to prevent increases in power consumption caused by continuously performing the conversion.

According to still another aspect of the invention, there is provided an electrophoretic apparatus including the aforementioned apparatus for driving an electrophoretic display unit and the electrophoretic display unit. In addition, there is provided an electronic device including the aforementioned electrophoretic apparatus.

In this case, since each characteristic of the aforementioned apparatus for driving the electrophoretic display unit is provided, it is possible to control a potential difference between the electrodes of the electrophoretic element by generating the driving control signal of the electrophoretic display unit based on the temperature equivalent value which changes depending on the solvent temperature without using a special temperature sensor. As a result, since the temperature sensor becomes dispensable, it is possible to reduce manufacturing cost of the electrophoretic apparatus or the entire electronic device.

Herein, the “driving control signal” implies a signal having a predetermined pulse width, a predetermined number of pulses, and a predetermined voltage for driving the electrophoretic display unit, including a signal for controlling the potential difference between the electrodes of the electrophoretic element.

Herein, the “electrophoretic display unit” implies an electro-optical display device including an electrophoretic display panel and a display unit having a highly-flexible film shape formed on a permeable substrate, in which at least one or a plurality of electrophoretic elements are provided to display images, text, or the like.

Herein, the “electronic device” includes all kinds of devices having a display unit which employs an electrophoretic apparatus, such as display devices, television, electronic paper, watches, electronic calculators, mobile phones, and portable information terminals. The invention may also be applied to other objects that do not belong to the concept of “device”, such as flexible paper/film-like objects, immovables such as walls that can be used to fix these objects, or movables such as vehicles, air vehicles, and ships.

Herein, the “ . . . unit” (wherein, the words before “unit” denote arbitrary words) means any object configured using an electronic circuit, but is not limited thereto. The “unit” includes a physical element for performing a corresponding function or a functional element implemented by software. A function of one unit may be implemented using two or more physical or functional elements, and functions of two or more units may be implemented using a single physical or functional element.

### BRIEF DESCRIPTION OF THE DRAWINGS

The invention will be described with reference to the accompanying drawings, wherein like numbers reference like elements.

FIG. 1 is a block diagram illustrating the entire configuration of an electrophoretic apparatus.

FIG. 2 illustrates a configuration of a pixel of an electrophoretic display unit.

FIG. 3 illustrates a configuration of an apparatus for driving the electrophoretic display unit according to a first embodiment of the invention.

FIG. 4 illustrates a configuration example of a differential amplifier.

FIG. 5 illustrates a configuration example of an instrumentation amplifier.

FIG. 6 is a semi-logarithmic graph illustrating a temperature characteristic of a driving current of the electrophoretic display unit.

FIG. 7 is a flowchart illustrating a method of driving the electrophoretic display unit according to a first embodiment of the invention.

FIG. 8 illustrates a configuration of an apparatus for driving the electrophoretic display unit according to a modified example of the first embodiment of the invention.

FIG. 9 illustrates a configuration of an apparatus for driving the electrophoretic display unit according to a second embodiment of the invention.

FIG. 10 illustrates a configuration of an apparatus for driving the electrophoretic display unit according to a third embodiment of the invention.

FIG. 11 illustrates a configuration of an apparatus for driving the electrophoretic display unit according to a fourth embodiment of the invention.

FIG. 12 illustrates a specific configuration example of a driving voltage generator.

FIG. 13 illustrates temperature dependency of a driving voltage output from the driving voltage generator.

FIG. 14 is a block diagram illustrating an entire configuration of a modified example of the electrophoretic apparatus.

FIG. 15 illustrates an exemplary circuit configuration of a pixel included in the electrophoretic apparatus.

FIGS. 16A to 16C are perspective views illustrating a specific example of an electronic device including the electrophoretic apparatus.

### DESCRIPTION OF EXEMPLARY EMBODIMENTS

Embodiments of the invention will now be described in detail with reference to the accompanying drawings. While the following embodiments illustrate the invention, they are not intended to limit the technical scope of the invention. Like reference numerals denote like elements throughout the drawings.

### First Embodiment

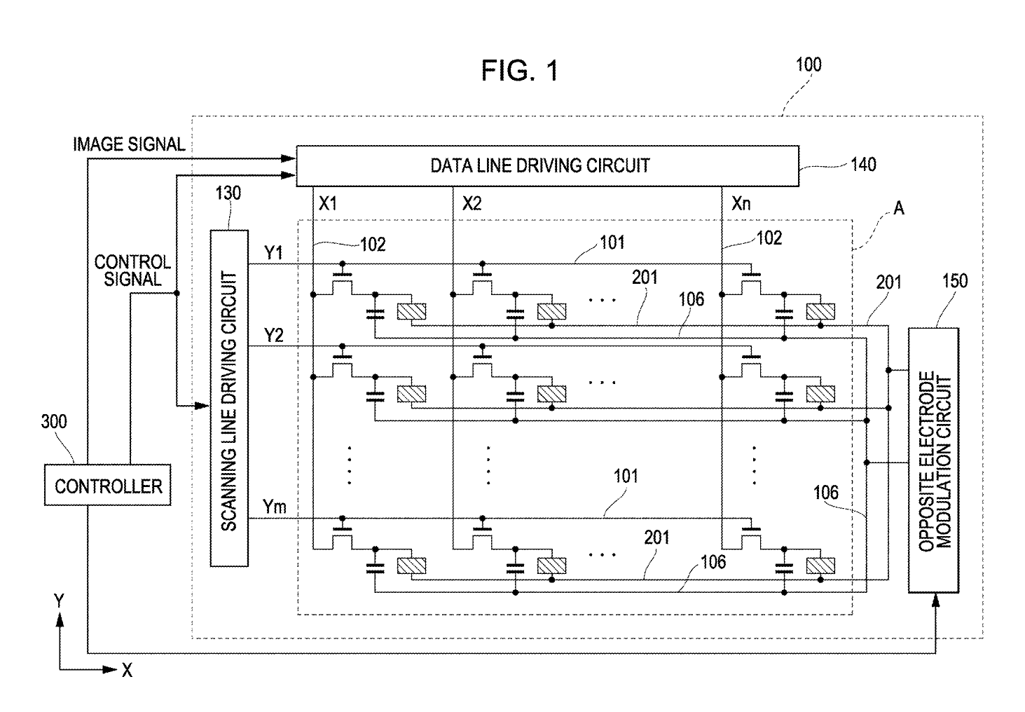

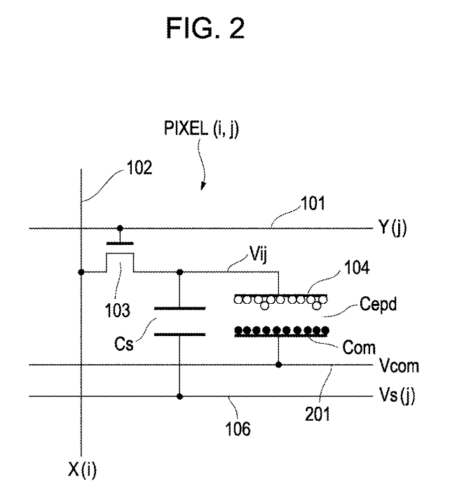

First, an exemplary configuration of an electrophoretic apparatus according to the invention will be described with reference to FIGS. 1 and 2.

FIG. 1 is a block diagram illustrating the entire configuration of an electrophoretic apparatus.

Referring to FIG. 1, the electrophoretic apparatus includes an electrophoretic display unit 100 and a controller 300.

A pixel region A of the electrophoretic display unit 100 according to a first embodiment of the invention includes a plurality of pixels. The pixel includes a TFT (thin-film transistor) 103, which will be described later, as a switching element and a pixel electrode 104 connected to the TFT 103. In the surroundings of the electrophoretic display unit 100, a scanning line driving circuit 130 and a data line driving circuit 140 are provided. In the pixel region A of the electrophoretic display unit 100, a plurality of scanning lines 101 are provided in parallel with the X-direction in the drawing. Further, a plurality of data lines 102 are provided in parallel with the Y-direction which is perpendicular to the X-direction. Each pixel is arranged in a matrix shape corresponding to intersections between the scanning lines 101 and the data lines 102.

A controller 300 is provided in a peripheral circuit of the electrophoretic apparatus. The controller 300 includes a display signal generator and a timing generator. The display signal generator generates an image signal and an opposite electrode control signal and inputs them to the data line driving circuit 140 and the opposite electrode modulation circuit 150, respectively. The opposite electrode modulation circuit 150 supplies a bias signal Vcom and a power voltage Vs to a common electrode of the pixel and an opposite electrode of the storage capacitor, respectively. For example, an image reset is established by a bias signal Vcom (i.e., a reset signal) having a positive or negative high level. The reset signal is output for a predetermined time period before the image signal is output from the data line driving circuit 140. The reset signal is used to initialize a spatial state by drawing electrophoretic particles, which are migrating in a dispersion medium, to the pixel electrode or the common electrode. The timing generator generates various timing signals for controlling the scanning line driving circuit 130 or the data line driving circuit 140 when the reset is established or the image signal is output from the display signal generator.

FIG. 2 illustrates an exemplary configuration of the pixel. The pixel (i, j) located in the i-th row and the j-th column includes a TFT 103, a pixel electrode 104, and a storage capacitor Cs. The gate terminal of the TFT 103 is connected to the scanning line 101, and the source terminal thereof is connected to the data line 102. Further, the drain terminal of the TFT 103 is connected to the pixel electrode 104 and the storage capacitor Cs. The storage capacitor Cs stores a voltage applied to the pixel electrode 104 by the TFT 103. Since the pixel is configured by interposing an electrophoretic layer between the pixel electrode 104 and the common electrode Com, a pixel capacitor Cepd is formed based on an electrode area, a distance between electrodes, and a dielectric constant of the electrophoretic layer. As described above, the common electrode Com is connected to the opposite electrode modulation circuit 150 through a wiring 201. In addition, the other side of the storage capacitor Cs is connected to the storage capacitor line 106. The storage capacitor line 106 is connected to the power Vs in the opposite electrode modulation circuit 150.

In this electrophoretic display unit 100, when all of the scanning line signals are activated in a reset timing, the TFT 103 connected to the j-th scanning line 101 is turned on. In a reset operation, all of the data signals are set to a white or black level, a reset signal is applied from the opposite electrode modulation circuit 150 to the common electrode Com, and all of the electrophoretic elements are set to a white or black display state (in a binary display type). Then, the scanning lines 101 are sequentially selected to record an image. When the TFT 103 connected to the j-th scanning line 101 is turned on, the data signal Xi (i.e., an image signal) supplied from the data line driving circuit 140 is written to the pixel electrode 104 in synchronization with the selection of the scanning line. At this moment, the storage capacitor Cs is charged to a voltage level of the data signal Xi so that charges of the pixel (i.e., the pixel electrode and the common electrode) can be stored, and the image can be retained by the electrophoretic particles even after the TFT 103 is cut off. An image is displayed by performing the display of each pixel depending on the voltage level of the data signal.

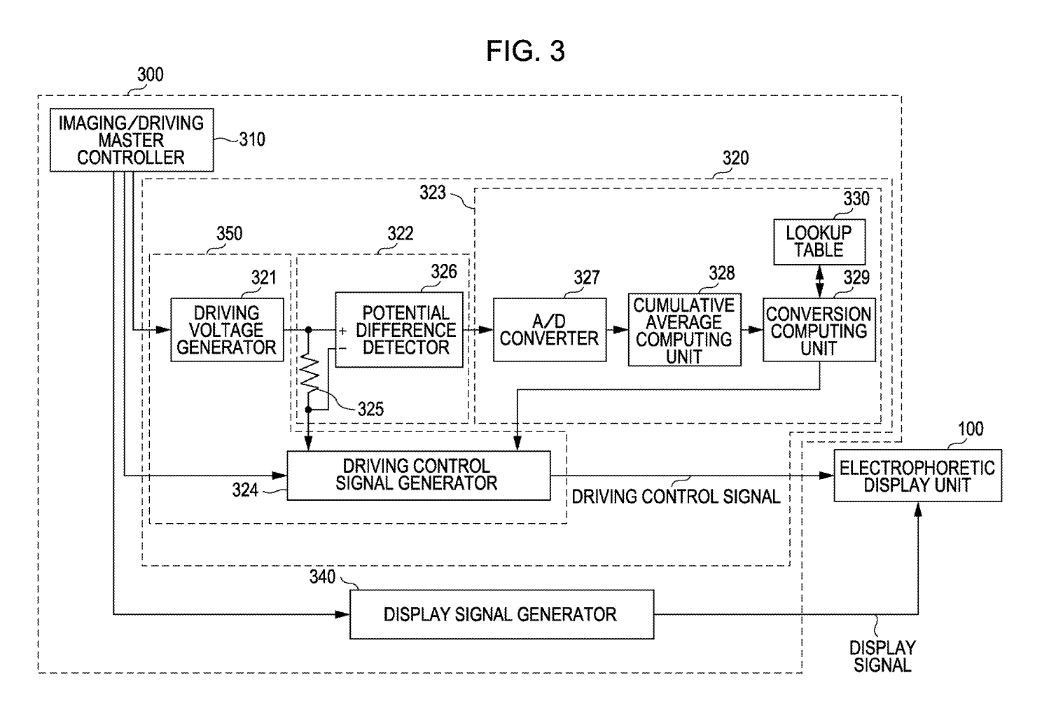

FIG. 3 illustrates a configuration of an apparatus for driving the electrophoretic display unit according to a first embodiment of the invention. Referring to FIG. 3, a controller 300 includes an imaging and driving master controller 310, a driver unit 320, and a display signal generator 340. Each of the driver unit 320 and the display signal generator 340 included in the controller 300 is connected to the electrophoretic display unit 100. The driver unit 320 includes a driving voltage generator 321, a current detector 322, a conversion unit 323, and a driving control signal generator 324. The current detector 322 includes a detection resistor 325 and a potential difference detector 326. The conversion unit 323 includes an A/D converter 327, a cumulative average computing unit 328, a conversion computing unit 329, and a lookup table 330.

Imaging and Driving Master Controller 310

The imaging and driving master controller 310 is configured to control the driver unit 320 and the display signal generator 340 in order to display an image on the electrophoretic display unit 100. More specifically, the imaging and driving master controller 310 instructs the driving voltage generator 321 of the driver unit 320 to turn on/off a power supply and instructs the driving control signal generator 324 to initiate the driving of the electrophoretic display unit 100. The imaging and driving master controller 310 transmits to the display signal generator 340 parameters of the image to be displayed on the electrophoretic display unit 100 in order to instruct the electrophoretic display unit 100 to initiate display. The imaging and driving master controller 310 can be implemented using technologies of the related art.

### Driving Voltage Generator 321

The driving voltage generator 321 is configured to generate a second voltage, which is a driving voltage for driving the electrophoretic display unit 100, based on a first voltage as a power voltage and supply the second voltage to the driving control signal generator 324. For example, according to a first embodiment of the invention, it is assumed that the power voltage is set to DC 3 V of a battery, and the driving voltage is set to 15 V. In this case, the driving voltage generator 321 functions as a voltage boosting circuit for boosting the power voltage from 3 V to 15 V.

### Current Detector 322

The current detector 322 is configured to detect the driving current of the driving control signal supplied from the driving voltage generator 321 to the electrophoretic display unit 100 through the driving control signal generator 324 and output a detection value corresponding to the driving current. As described above, the current detector 322 according to a first embodiment of the invention includes a detection resistor 325 and a potential difference detector 326 to implement the aforementioned functions. That is, the detection resistor 325 has a predetermined resistance value and is connected in series between the driving voltage generator 321 as a driving voltage source and the electrophoretic display unit 100. The potential difference detector 326 is configured to include, for example, a differential amplifier and receive potentials of both ends of the detection resistor 325 and output a potential difference therebetween. It is readily understood that, since the resistance value of the detection resistor 325 is constant, the detected potential difference is proportional to the current value flowing through the detection resistor 325 based on Ohm's law. That is, the potential difference detected by the potential difference detector 326 is considered as a driving current equivalent value which is proportional to the driving current. As described above, the potential difference detector 326 can output as a detection value a driving current equivalent value based on the detection result.

Since the current detector 322 is configured to include the detection resistor 325 and the potential difference detector 326 as described above, it is possible to measure a potential difference corresponding to a driving current of the electrophoretic display unit 100 using the detection resistor 325 instead of directly measuring the driving current. As a result, it is possible to inexpensively provide the current detector and the apparatus for driving the electrophoretic display unit having a simple configuration.

In addition, the current detector 322 can be implemented by other configurations that can perform the same function and may include various other alternatives. For example, the potential difference detector 326 is not limited to the differential amplifier, but may include other configurations if a potential difference can be detected by measuring a potential between both ends of the detection resistor 325. Specifically, a differential amplifier or an instrumentation amplifier may be employed as described below.

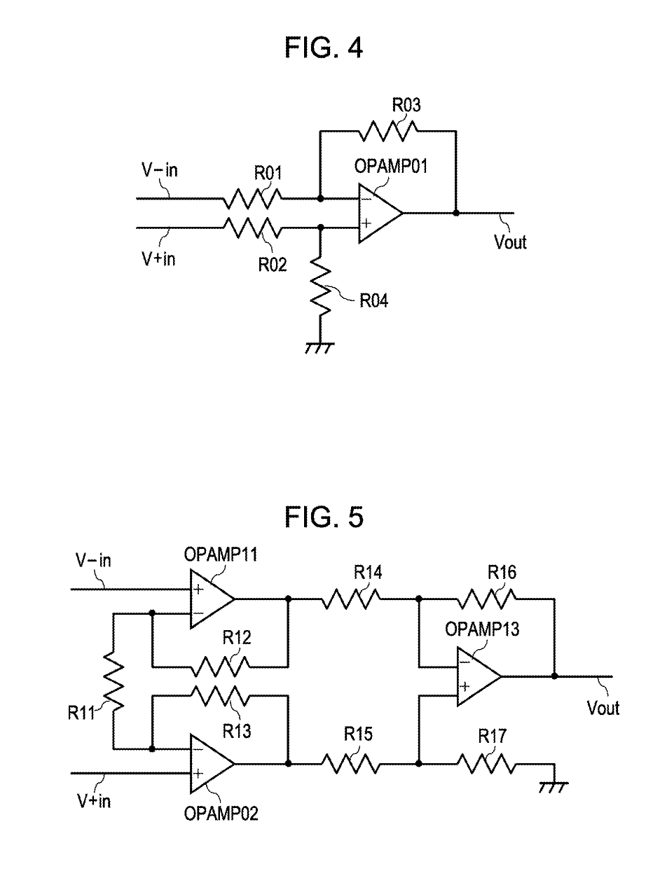

FIG. 4 illustrates a configuration example of a differential amplifier, and FIG. 5 illustrates a configuration example of an instrumentation amplifier. Referring to FIG. 4, the differential amplifier includes, for example, an operational amplifier OPAMP01 and four resistors R01 to R04 to obtain an output voltage Vout from a positive input V+in and a negative input V−in. Referring to FIG. 5, the instrumentation amplifier includes, for example, three operational amplifiers OPAMP11 to OPAMP 13 and seven resistors R11 to R17. The instrumentation amplifier also obtains an output voltage Vout from a positive input V+in and a negative input V−in. While configuration examples of the potential difference detector 326 have been described for illustrative purposes, the potential difference detector 326 may be configured in other ways.

In addition, it is preferable that a voltage drop at the detection resistor 325 is set to 1/100 or less of the power voltage considering the driving voltage is dropped by connection. For example, if the driving current is in the order of 100 μA, the resistance value of the detection resistor may be set to about 1 kΩ. By using such a detection resistor 325, it is possible to operate the electrophoretic display unit without adverse influence on the operation or display contrast thereof even when the voltage is dropped by the detection resistor 325.

### Conversion Unit 323

The conversion unit 323 is configured to obtain a detection value corresponding to the driving current detected by the current detector 322 and convert it to a corresponding temperature equivalent value. As described above, according to a first embodiment of the invention, the conversion unit 323 includes an A/D converter 327, a cumulative average computing unit 328, a conversion computing unit 329, and a lookup table 330 to implement the aforementioned functions.

### A/D Converter 327

The A/D converter 327 is configured to convert the detection value output from the current detector 322 from an analog value into a digital value. The A/D converter 327 with a desired number of bits required by the driver unit 320 of the electrophoretic display unit 100 may be applicable. For example, if several different combinations of the driving control signal of the electrophoretic display unit 100 can sufficiently prevent the contrast of the electrophoretic display unit 100 from deteriorating, the A/D converter 327 does not require a high precision (i.e., the number of bits), and may be configured, for example, using a simple comparator. Furthermore, the A/D converter 327 may be implemented based on technologies of the related art.

### Cumulative Average Computing Unit 328

The cumulative average computing unit 328 is configured to output a cumulative average value obtained by adding and averaging the digital value of the detection value converted from an analog value to a digital value by the A/D converter 327 for a time that is determined in advance. That is, the cumulative average value is a integrated value (i.e., the driving current value or the driving current equivalent value) per unit time.

### Conversion Computing Unit 329

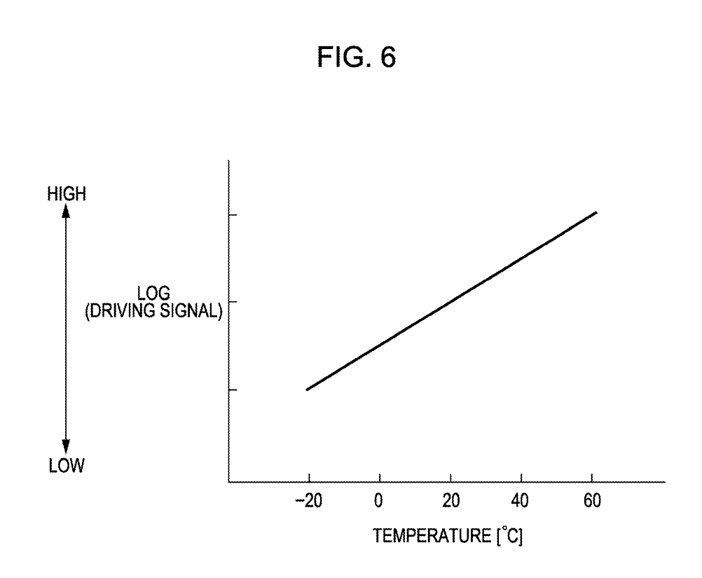

The conversion computing unit 329 is configured to convert the cumulative average value obtained by the cumulative average computing unit 328 into a corresponding temperature equivalent value. It is noted that the driving current supplied to the electrophoretic display unit 100 increases as the temperature of the electrophoretic display unit 100 increases. Hereinafter, this will be described in brief with reference to FIG. 6.

FIG. 6 is a semi-logarithmic graph representing a temperature characteristic of the driving current supplied to the electrophoretic display unit 100. In this graph, the abscissa axis denotes a temperature of the electrophoretic display unit 100, and the ordinate axis denotes a driving current supplied to the electrophoretic display unit 100 from the driving voltage generator 321 in a logarithmic representation. Herein, the driving current means the current required to drive the electrophoretic display unit 100 connected to the output of the driving voltage generator 321. As shown in FIG. 6, the driving current of the electrophoretic display unit 100 is strongly dependent on the temperature and exponentially increases as the temperature increases. As can be readily seen from the drawing, since there is a certain relationship between the driving current and the temperature, the temperature can be determined by measuring the driving current. By using the relationship between the driving current and the temperature, the conversion computing unit 329 can estimate the temperature of the electrophoretic display unit 100 based on the cumulative average value which is a detection value (a driving current value or a driving current equivalent value) per unit time.

### Lookup Table 330

Referring to FIG. 3, the conversion computing unit 329 is configured to convert the cumulative average value into a corresponding temperature equivalent value with reference to a lookup table 330 that has been previously prepared. The lookup table 330 has a table relating to a temperature characteristic of the driving current supplied to the electrophoretic display unit 100 as described above in association with FIG. 6. According to a first embodiment of the invention, the table represents the temperature uniquely determined corresponding to the cumulative average value which is a detection value (a driving current value or a driving current equivalent value) per unit time.

Since the conversion computing unit 329 is configured to refer to the lookup table 330 that has been previously prepared, the cumulative average value can be converted into the temperature equivalent value based on a limited combination, and the conversion can be performed by the conversion computing unit 329 through a relatively simple operation.

While the first embodiment of the invention has been described by exemplifying that the lookup table 330 is a list of actual values, the invention is not limited thereto. The temperature equivalent value may be obtained based on a numerical formula including the cumulative average value input from the conversion computing unit 329 as a parameter.

The conversion unit 323 includes at least an A/D converter 327, a cumulative average computing unit 328, and a conversion computing unit 329 and thus performs computing operations using a detection value converted to a digital value by the A/D converter 327. Therefore, it is possible to avoid increasing the number of analog components, which is easy to increase in size. As a result, it is possible to package the apparatus 320 for driving the electrophoretic display unit 100 within a limited packaging volume. Further, it is possible to avoid increases in cost caused by increasing the number of analog components.

Although the electrophoretic display unit of the invention is influenced by changes in temperature, the temperature of the solvent of the electrophoretic display unit changes smoothly in comparison with the atmospheric temperature even when the surrounding atmospheric temperature changes abruptly. Further, the surrounding atmospheric temperature seldom changes abruptly. In this regard, it is preferable that the conversion unit 323 performs conversion at an interval that is determined in advance based on change of the response speed of the electrophoretic display unit corresponding to change of the atmospheric temperature. While the time interval that is determined in advance may be arbitrarily selected, it is preferably set to 5 to 10 minutes on an empirical basis. The image displayed on the electrophoretic display unit may be converted into the temperature equivalent value from the driving current in synchronization with the timing when the displayed image is updated by manipulation such as page-turnover. As a result, it is possible to prevent increases in power consumption caused by continuously performing conversion in the conversion unit 323.

### Driving Control Signal Generator 324

The driving control signal generator 324 is configured to generate the driving control signal of the electrophoretic display unit 100 based on the temperature equivalent value that is obtained by the conversion computing unit 329 of the conversion unit 323 and the driving voltage input from the driving voltage generator 321. It is noted that the driving control signal is a signal having a predetermined pulse width, a predetermined number of pulses, and a predetermined voltage for driving the electrophoretic display unit 100. The driving control signal generator 324 is configured to change at least one of the pulse width, the number of pulses, and the voltage of the driving control signal. The driving control signal generator 324 supplies the generated driving control signal to the electrophoretic display unit 100. In this way, the driving control signal generator 324 operates the electrophoretic display unit 100. In addition, the driving control signal may be generated based on technologies of the related art by setting conditions of a predetermined pulse width, a predetermined number of pulses, and a predetermined voltage.

### Driver 350

It is noted that, as shown in FIG. 3, the driver 350 may include the driving voltage generator 321 and the driving control signal generator 324.

### Display Signal Generator 340

The display signal generator 340 is configured to generate a display signal for displaying an image on the electrophoretic display unit 100 and output this to the electrophoretic display unit 100.

The display signal generator 340 sometimes displays a compensation image between the immediately previous image and the next display image because, if the image displayed on the electrophoretic display unit 100 is directly rewritten from the immediately previous image to the next display image, an afterimage of the immediately previous image may remain. An image having a certain color such as a completely black color, a completely white color, or a predetermined gray scale, or another predetermined color is used as the compensation image. In this case, while the conversion unit 323 obtains the detection value detected by the current detector 322 and converts it into a corresponding temperature equivalent value as described above, it is preferable that these obtaining and converting timings are set to a time period where the display signal generated by the display signal generator 340 is used for the compensation image. As a result, deviation in the driving current caused by changing the display image can be prevented. That is, if the display image changes in each case, the driving current changes even at the same temperature. However, if the display image is determined in advance, the driving current becomes the same at the same temperature. As a result, it is guaranteed that the current detector outputs the detection value corresponding to the driving current only depending on the temperature irrespective of the display image. Since the temperature equivalent value converted based on the detection value corresponding to the driving current irrespective of the display image is used, the driving control signal generator 324 can more appropriately generate the driving control signal of the electrophoretic display unit 100.

Furthermore, the compensation image may be set to an image, which allows a large driving current to be supplied to the electrophoretic display unit 100, such as a checkered pattern of black and white colors. As a result, since the conversion unit 323 converts the detection value corresponding to a relatively large driving current, detection error regarding the driving current is relatively reduced. Accordingly, it is possible to more appropriately generate the driving control signal.

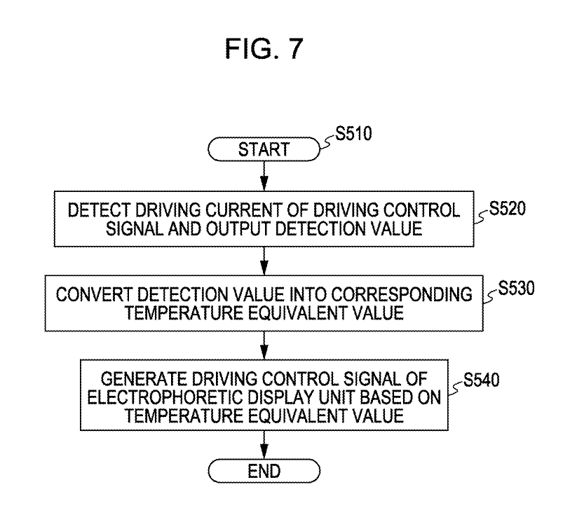

A method of driving the electrophoretic display unit according to a first embodiment of the invention will now be described in brief with reference to FIG. 7.

FIG. 7 is a flowchart illustrating a method of driving the electrophoretic display unit according to a first embodiment of the invention. This method is performed by the apparatus 320 for driving the electrophoretic display unit 100 shown in FIG. 3.

When the method of driving the electrophoretic display unit 100 is initiated (S510), the current detector 322 detects the driving current of the driving control signal supplied to the electrophoretic display unit 100 and outputs a detection value corresponding to the driving current (S520). While this current detection step S520 is performed by the current detector 322 as shown in FIG. 3, the invention is not limited to the configuration obtained by combining the detection resistor 325 and the potential difference detector 326 shown in FIG. 3, but other configurations may be employed if the aforementioned functions of the current detection step S520 can be implemented.

Next, the conversion unit 323 converts the detection value output in the current detection step S520 into a corresponding temperature equivalent value (S530). This conversion may be performed using, for example, a lookup table representing a relationship between the detection value and the temperature equivalent value. While this conversion step S530 is performed by the conversion unit 323 as shown in FIG. 3, the invention is not limited thereto. Instead of the lookup table, the conversion may be performed based on a numerical formula capable of calculating the temperature equivalent value by using the detection value as a parameter.

The driving control signal generator 324 generates the driving control signal of the electrophoretic display unit 100 based on the temperature equivalent value that is obtained in the conversion step S530 (S540). The driving control signal has parameters such as a pulse width, the number of pulses, and a voltage. Proper parameters are determined based on the temperature equivalent value. The driving control signal is generated based on the determined parameters. This driving control signal generation step S540 is performed by the driving control signal generator 324 as shown in FIG. 3.

In this case, it is possible to generate the driving control signal of the electrophoretic display unit 100 based on the solvent temperature without using a special temperature sensor, thereby driving the electrophoretic display 100. As a result, the special temperature sensor becomes dispensable, and the manufacturing cost can be reduced.

In a case where the solvent temperature is measured using a temperature sensor of the related art, the measurement result is sometimes different from the actual solvent temperature depending on the location in which the temperature sensor is disposed. For example, a small-sized electronic device such as a wristwatch often has a different temperature depending on the measurement location even within the wristwatch because human body temperature measured at a surface making contact with human skin is significantly different from an external atmospheric temperature measured at a surface making contact with an external atmosphere in a cold winter season. In this case, since the small-sized electronic device such as a wristwatch is configured within a limited packaging volume, it may be impossible to dispose the temperature sensor near the electrophoretic display unit whose temperature is desired to be measured. Accordingly, the temperature sensor is inevitably disposed far from the electrophoretic display unit, and thus, the actual solvent temperature cannot be measured. Furthermore, since the driving control signal of the electrophoretic display unit is generated based on the detected temperature different from the actual solvent temperature, contrast of the electrophoretic display unit may be deteriorated.

According to a first embodiment of the invention, the detection value corresponding to the driving current of the driving control signal supplied to the electrophoretic display unit 100 is used to generate the driving control signal. Since this detection value changes depending on the temperature of the electrophoretic display unit 100 irrespective of the location in which the current detector 322 is disposed, it is possible to accurately generate the driving control signal corresponding to the temperature of the electrophoretic display unit 100.

### Modified Example of First Embodiment

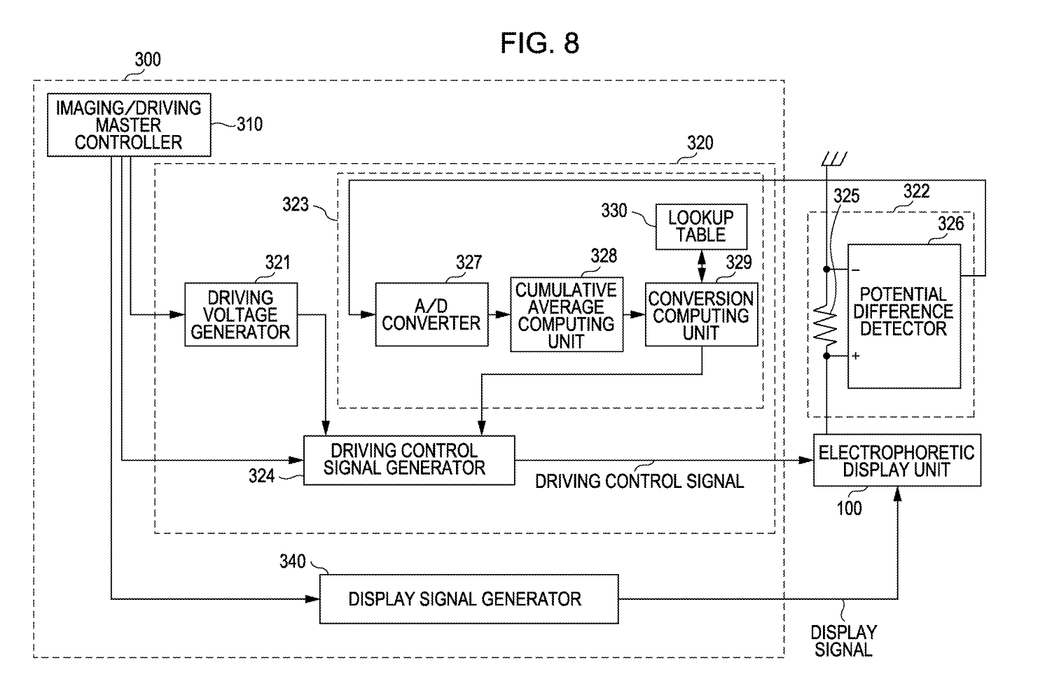

FIG. 8 illustrates a configuration of a modified example of a first embodiment of the invention. Referring to FIG. 8, in comparison with FIG. 3, it is understood that the location of the current detector 322 is modified.

According to this modified example, the current detector 322 is configured to detect the driving current flowing from the electrophoretic display unit 100 to the ground potential and outputs a detection value corresponding to the detected driving current. The configuration of the current detector 322 is basically equal to the first embodiment of the invention. In this configuration, the potential difference detected by the potential difference detector 326 is a driving current equivalent value which is proportional to the driving current. That is, since the conversion unit 323 can obtain the temperature equivalent value based on the detection value output from the potential difference detector 326, the functions of the first embodiment of the invention can be similarly implemented even in this modified example.

According to this modified example, since one end of the detection resistor 325 is connected to a ground potential, it is possible to configure the potential difference detector 326 using a simple amplification circuit.

In this case, since the potential difference detector 326 can be simplified, it is possible to select more options regarding the circuit configuration.

As understood from this modified example, the configuration of the driver unit 320 is not limited to that described in association with the first embodiment of the invention. Instead, the current detector 322 may be configured to detect the driving current flowing from the electrophoretic display unit 100 to a ground potential. That is, the detection resistor 325 included in the current detector 322 may be disposed between the driving voltage generator 321 and the electrophoretic display unit 100 or between the electrophoretic display unit 100 and a ground potential.

### Second Embodiment

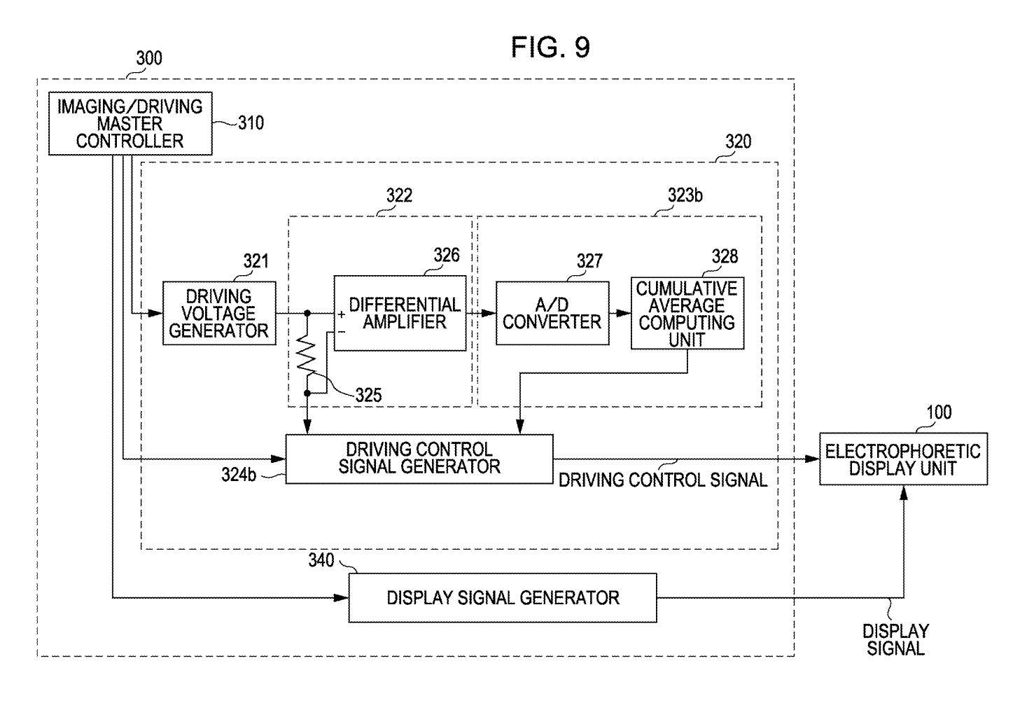

FIG. 9 illustrates a configuration of a driver unit 320 of an electrophoretic display unit 100 according to a second embodiment of the invention. Comparing first and second embodiments of the invention, the conversion unit 323 and the driving control signal generator 324 of the first embodiment correspond to the conversion unit 323b and the driving control signal generator 324b of the second embodiment, but their configurations and functions are different from each other. Other configurations and functions are similar between the first and second embodiments.

Referring to FIG. 9, the conversion unit 323b and the driving control signal generator 324b which are included in the driver unit 320 are different from those of the first embodiment as described above. The conversion unit 323b includes the A/D converter 327 and the cumulative average computing unit 328.

### Conversion Unit 323b

The conversion unit 323b is configured to obtain a detection value detected by the current detector 322 and output a cumulative average value of the detection value. That is, unlike the first embodiment in which the temperature equivalent value is output, the cumulative average value is output. The conversion unit 323b according to the second embodiment includes an A/D converter 327 and a cumulative average computing unit 328 to implement this function.

### A/D Converter 327

Similar to the first embodiment, the A/D converter 327 is configured to convert the detection value output from the current detector 322 from an analog value into a digital value. The A/D converter 327 with the number of bits required in the driver unit 320 of the electrophoretic display unit 100 may be applicable. For example, if several different combinations of the driving control signal of the electrophoretic display unit 100 can sufficiently prevent the contrast of the electrophoretic display unit 100 from deteriorating, the A/D converter 327 does not require a high precision (i.e., the number of bits), and may be configured, for example, using a simple comparator. Furthermore, the A/D converter 327 may be implemented based on technologies of the related art.

### Cumulative Average Computing Unit 328

The cumulative average computing unit 328 is configured to output a cumulative average value obtained by adding and averaging the digital value of the detection value converted from an analog value into a digital value by the A/D converter 327 for a time that is determined in advance.

### Driving Control Signal Generator 324b

Unlike the first embodiment, the driving control signal generator 324b generates the driving control signal of the electrophoretic display unit 100 based on the cumulative average value that is obtained by the cumulative average computing unit 328 of the conversion unit 323b. Specifically, the driving control signal generator 324b obtains the cumulative average value obtained by the cumulative average computing unit 328 before it is converted into the corresponding temperature equivalent value. Since there is a certain relationship between the driving current and the temperature of the electrophoretic display unit 100 as described above in association with the graph of FIG. 6 in the first embodiment, measuring the driving current is considered equal to determining the temperature. In this regard, the driving control signal generator 324b can generate the driving control signal for driving the electrophoretic display unit 100 based on the cumulative average value, for example, using a lookup table representing the relationship between the cumulative average value and the driving control signal instead of using the temperature or the temperature equivalent value.

In this way, it is possible to generate the driving control signal for driving the electrophoretic display unit 100 using the conversion unit 323b and the driving control signal generator 324b different from the conversion unit 323 and the driving control signal generator 324 of the first embodiment without converting the cumulative average value into the temperature equivalent value. As a result, since the process of converting the cumulative average value into the temperature equivalent value can be removed, the power consumption can be reduced. In addition, since the conversion computing unit 329 of the first embodiment becomes dispensable, it is possible to reduce the circuit size or the cost.

While a second embodiment of the invention has been described by exemplifying that the driving control signal is generated using the lookup table based on the cumulative average value, the driving control signal may not necessarily be generated using the lookup table but may be generated based on a predetermined numerical formula using the cumulative average value as a parameter.

### Third Embodiment

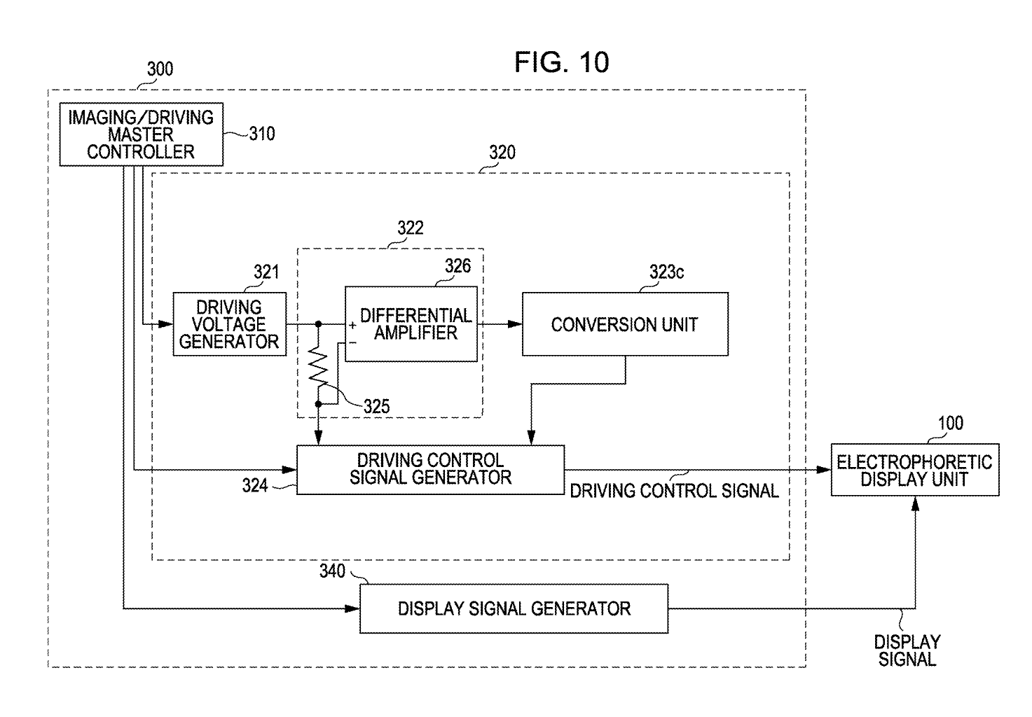

FIG. 10 illustrates a configuration of an apparatus 320 for driving the electrophoretic display unit 100 according to a third embodiment of the invention. Comparing the first and third embodiments, the conversion unit 323 of the first embodiment is modified into a conversion unit 323c of the third embodiment. The configuration and function thereof are similar to those of the first embodiment.

### Conversion Unit 323c

The conversion unit 323c is configured to obtain the detection value detected by the current detector 322 and convert it into the temperature equivalent value corresponding to the detection value. In this case, since the detection value is an analog value corresponding to the current equivalent value of the driving control signal, it is possible to obtain a voltage value by smoothing the current equivalent value using, for example, a low-pass filter circuit consisting of a condenser having a sufficient capacity and a resistor having a predetermined resistance value. The functions of the conversion unit 323c can be implemented by converting this voltage value into a digital value using the A/D converter and converting the digital value into a temperature equivalent value with reference to a lookup table representing a relationship between this digital value and the temperature equivalent value.

In addition, various configurations may be contemplated to convert the detection value into the temperature equivalent value corresponding to the detection value using the conversion unit 323c, and, according to the invention, the conversion unit 323c may include other configurations having a similar function. For example, a logarithmic transform circuit for directly converting the analog current equivalent value detected by the current detector 322 into the analog temperature equivalent value may be provided. As a result, it is possible to implement the function of the conversion unit without using the digital circuit.

In this case, similar to the first embodiment, it is possible to generate the driving control signal of the electrophoretic display unit 100 based on the solvent temperature without using a special temperature sensor to drive the electrophoretic display unit 100. As a result, a special temperature sensor becomes dispensable, and the manufacturing cost can be reduced.

### Fourth Embodiment

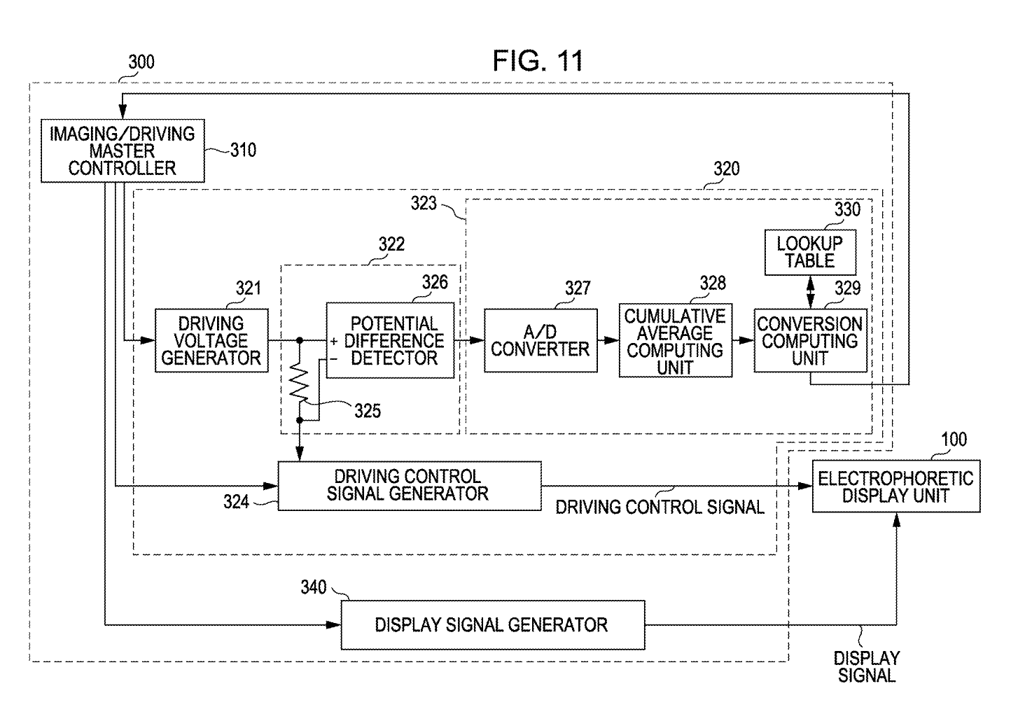

FIG. 11 illustrates a configuration of an apparatus 320 for driving an electrophoretic display unit 100 according to a fourth embodiment of the invention. Comparing the first and fourth embodiments, the temperature equivalent value output from the conversion unit 323 is input not to the driving control signal generator 324 but to the imaging and driving master controller 310.

Specifically, when the temperature of the electrophoretic display unit 100 changes, the loading current of the driving voltage generator 321 increases, whereas a boosting capability decreases. When the boosting capability decreases, the driving voltage generator 321 may fail to boost the driving voltage to a desired level. In this regard, according to a fourth embodiment of the invention, a switching frequency of a switching pulse used in the operation of the driving voltage generator 321 is changed based on the temperature equivalent value output from the conversion unit 323. Hereinafter, a fourth embodiment of the invention will be described in more detail.

FIG. 12 illustrates a specific configuration example of the driving voltage generator 321. Referring to FIG. 12, the driving voltage generator 321 includes a five-stage unit boosting circuit connected in series between the input terminal IN and the output terminal OUT. For example, a low voltage LVDD (e.g., 3 V) of a battery (not shown in the drawing) is applied to the input terminal IN, whereas a boosted high DC voltage HVDD (e.g., 18 V) is output from the output terminal OUT. Each unit boosting circuit includes three switch elements and a single condenser (i.e., capacitor). For example, as shown as a dotted line in the drawing, a first unit boosting circuit includes switch elements SW1a, SW2a, and SW2a′ and a condenser Ca.

In the first unit boosting circuit, a switch element SW1a is connected between the input terminal and the output terminal thereof. Switch elements SW2a and SW2a′ are connected in series between the input terminal of the unit boosting circuit and a reference potential (e.g., a ground potential). A condenser Ca is connected between a common node of the switch elements SW2a and SW2a′ and the output terminal of the unit boosting circuit. The switch elements SW2a and SW2a′ are complementary to each other, and the switch elements SW1a and SW2a are a same type. When the switch elements SW1a and SW2a′ are conducted, the switch element SW2a is not conducted. When the switch elements SW1a and SW2a′ are not conducted, the switch element SW2a is conducted.

In such a switched capacitor type boosting circuit, the input voltage is boosted by setting a DC power source as an input voltage as described above and alternately performing a charge operation, in which the condenser is connected in parallel to the DC power source to be charged, and a discharge operation, in which the condenser is connected in series to the DC power source to discharge, to output the boosted voltage higher than the input voltage. According to fourth embodiment of the invention, the output voltage as a driving voltage is output to the driving control signal generator 324 via the current detector 322. Such charge and discharge operations are performed while switching the operations by the switching pulse having a predetermined switching frequency. The switching pulse is input from the imaging and driving master controller 310. That is, the driving voltage generator 321 generates the driving voltage by boosting the input voltage using the switching frequency of the switching pulse.

In the driving voltage generator 321 as a boosting circuit, current supply capability increases as the switching frequency thereof increases. On the other hand, the current supply capability decreases as the switching frequency decreases. Meanwhile, as the switching frequency increases, the power consumption accordingly increases. Therefore, if the driving voltage generator 321 is always operated at a high switching frequency, this means that power is needless consumed.

In this regard, according to a fourth embodiment of the invention, the temperature equivalent value output from the conversion unit 323 is input to the imaging and driving master controller 310 as shown in FIG. 11. The imaging and driving master controller 310 controls a switching frequency of the switching pulse to be supplied to the driving voltage generator 321 based on the temperature equivalent value. More specifically, the imaging and driving master controller 310 raises the switching frequency of the switching pulse to be supplied to the driving voltage generator 321 when the obtained temperature equivalent value represents a high temperature. On the other hand, the imaging and driving master controller 310 reduces the switching frequency of the switching pulse to be supplied to the driving voltage generator 321 when the obtained temperature equivalent value represents a low temperature.

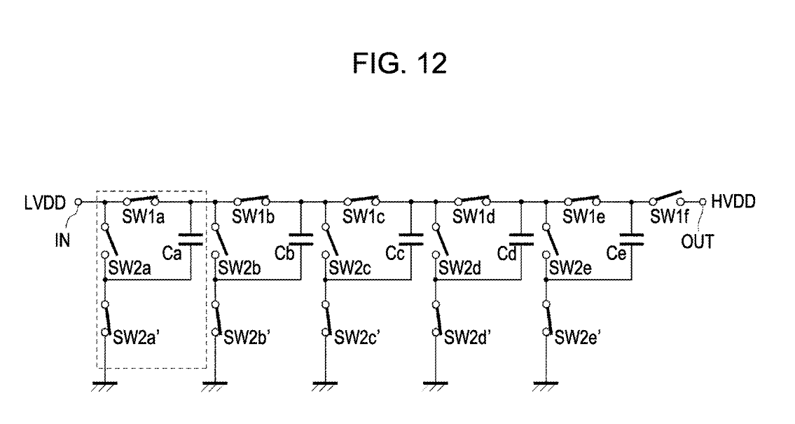

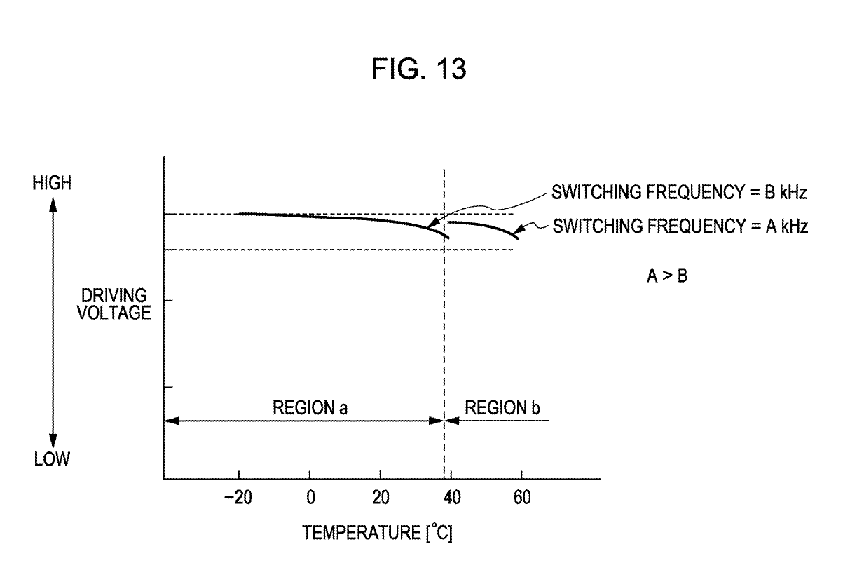

FIG. 13 illustrates a change of the driving voltage output from the driving voltage generator 321 depending on temperature. Referring to FIG. 13, the switching frequency of the switching pulse is changed depending on temperature. In FIG. 13, the abscissa axis represents the temperature corresponding to the temperature equivalent value, and the ordinate axis represents the driving voltage output from the driving voltage generator 321. Referring to FIG. 13, it is noted that, in a region a where the switching frequency of the switching pulse is B kHz, the driving voltage decreases as the switching frequency increases. This is because the boosting capability of the driving voltage generator 321 is reduced. At the time point when a temperature corresponding to the temperature equivalent value becomes 40° C., the imaging and driving master controller 310 changes the switching frequency of the switching pulse to be supplied to the driving voltage generator 321 from B kHz to A kHz (wherein, B<A). As a result, it is possible to prevent the driving voltage from decreasing over an allowable range even in a region b where the temperature corresponding to the temperature equivalent value is equal to or higher than 40° C.

According to a fourth embodiment of the invention, the driving voltage generator 321 generates the driving voltage by boosting the input voltage using a frequency signal having a predetermined frequency, and the imaging and driving master controller 310 changes the frequency of the frequency signal based on the temperature equivalent value.

In this case, it is possible to control the potential difference between the electrodes of the electrophoretic element by obtaining the temperature equivalent value, which changes depending on the solvent temperature, and changing the driving control signal of the electrophoretic display unit based on the temperature equivalent value without using the temperature sensor.

The values represented in the aforementioned embodiment are exemplary, and the invention is not limited thereto. The switching frequency of the switching pulse supplied from the imaging and driving master controller 310 to the driving voltage generator 321 may be changed not only in two steps but also in three or more multiple steps. Further, in the boosting circuit as a specific example of the driving voltage generator 321 shown in FIG. 12, other boosting circuits of the related art may be employed if the driving capability is increased by raising the switching frequency.

### Modified Example of Electrophoretic Apparatus

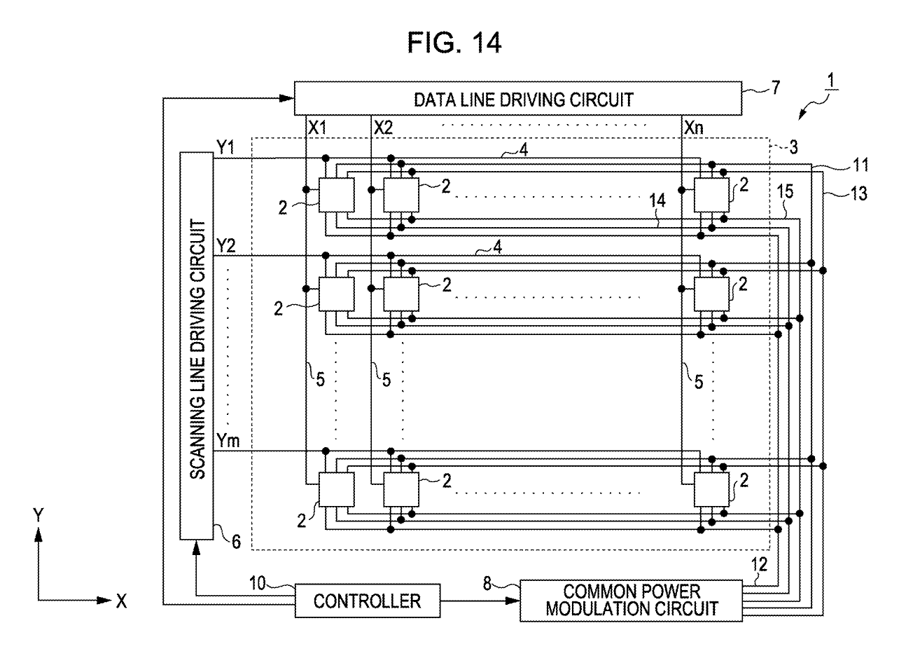

A modified example of the electrophoretic apparatus will be described with reference to FIGS. 14 and 15. The aforementioned driver unit may be employed as a driver unit in a display unit 3 of an electrophoretic apparatus which will be described below as well as in the electrophoretic display unit 100.

FIG. 14 is a block diagram illustrating the entire configuration of the electrophoretic apparatus according to this modified example of the invention. Referring to FIG. 14, the electrophoretic apparatus 1 includes a display unit 3, a scanning line driving circuit (pixel driver) 6, a data line driving circuit (pixel driver) 7, a common power modulation circuit (potential controller) 8, and a controller 10.

The display unit 3 has a matrix shape including M pixels 2 along a Y-axis direction and N pixels 2 along a X-axis direction. The scanning line driving circuit 6 is connected to the pixels 2 of the display unit 3 via a plurality of scanning lines 4 (Y1, Y2, . . . , Ym) extending along a X-axis direction. The data line driving circuit 7 is connected to the pixels 2 of the display unit 3 via a plurality of data lines 5 (X1, X2, . . . , Xn) extending along a Y-axis direction. The common power modulation circuit 8 is connected to the pixels 2 via a first control line 11, a second control line 12, a first power line 13, a second power line 14, and a common electrode power line (third control line) 15. The scanning line driving circuit 6, the data line driving circuit 7, and the common power modulation circuit 8 are controlled by the controller 10. The control line 11 and 12, the power line 13 and 14, and the common electrode power line 15 are used as a common line for all the pixels 2.

FIG. 15 illustrates an example of a specific circuit configuration of the pixels 2 included in the electrophoretic apparatus. Referring to FIG. 15, the pixel 2 includes a driving TFT (Thin Film Transistor; corresponding to a pixel switching element) 24, an SRAM (Static Random Access Memory; corresponding to a memory circuit) 25, a switch circuit 35, a pixel electrode (corresponding to a first electrode) 21, a common electrode (corresponding to a second electrode) 22, and an electrophoretic element 23.

The driving TFT 24 includes an N-MOS (N-channel Metal Oxide Semiconductor) transistor. A gate, a source, and a drain of the driving TFT 24 are connected to the scanning line 4, the data line 5, and SRAM 25, respectively. The driving TFT 24 is used to input to the SRAM 25 the image signal input from the data line driving circuit 7 via the data line 5 by connecting the data line 5 and the SRAM 25 during a time period when a selection signal is input from the scanning line driving circuit 6 via the scanning line 4.

The SRAM 25 includes two P-MOS (P-channel Metal Oxide Semiconductor) transistors 25p1 and 25p2 and two N-MOS transistors 25n1 and 25n2. The first power line 13 is connected to the source sides of the P-MOS transistors 25p1 and 25p2, and the second power line 14 is connected to the source side of the N-MOS transistors 25n1 and 25n2.

The drain sides of the P-MOS transistor 25p1 and the N-MOS transistor 25n1 of the SRAM 25 are connected to the driving TFT 24, the gate of the P-MOS transistor 25p2, the gate of the N-MOS transistor 25n2, a gate of an N-MOS transistor 36n of a first transfer gate 36, and a gate of a P-MOS transistor 27p of a second transfer gate 37.

The drain sides of the P-MOS transistor 25p2 and the N-MOS transistor 25n2 of the SRAM 25 are connected to the gate of the P-MOS transistor 25p1, the gate of the N-MOS transistor 25n1, the gate of the P-MOS transistor 36p of the first transfer gate 36, and the gate of the N-MOS transistor 37n of the second transfer gate 37.

The SRAM 25 is used to store the image signal transmitted from the driving TFT 24 and also input the image signal to the switch circuit 35.

The switch circuit 35 includes the first transfer gate 36 and the second transfer gate 37.

The P-MOS transistor 36p and the N-MOS transistor 36n are connected in the first transfer gate 36 in parallel, and the P-MOS transistor 37p and the N-MOS transistor 37n are connected in the second transfer gate 37 in parallel.

The source side of the first transfer gate 36 is connected to the first control line 11, and the source side of the second transfer gate 37 is connected to the second control line 12. The drain sides of the transfer gate 36 and 37 are connected to the pixel electrode 21.

The switch circuit 35 functions as a selector which selects one of the control lines 11 and 12 based on the image signal input from the SRAM 25 and connects the selected control line to the pixel electrode 21. It is noted that only one of the transfer gates 36 and 37 is operated depending on the level of the image signal.

The control line 11 or 12 is conducted to the pixel electrode 21 via the operated transfer gate to input a potential to the pixel electrode 21.

The electrophoretic element 23 is to display an image based on a potential difference between the pixel electrode 21 and the common electrode 22. The common electrode 22 is connected to the common electrode power line 15.

As described above, the driver unit according to an embodiment of the invention can be applied to an apparatus for driving the electrophoretic display unit in any of electrophoretic apparatuses described above. Alternatively, the driver unit according to the invention may be applied to an apparatus for driving the electrophoretic display unit in which the output terminal of the SRAM 25 and the pixel electrode are directly connected by removing the transfer gates 36 and 37 from the electrophoretic display unit according to the modified example, as well as to the electrophoretic display unit as described in this modified example. Furthermore, the driver unit according to the invention may be applied as a driving circuit of a so called segment type electrophoretic display unit or the like.

### Application Example

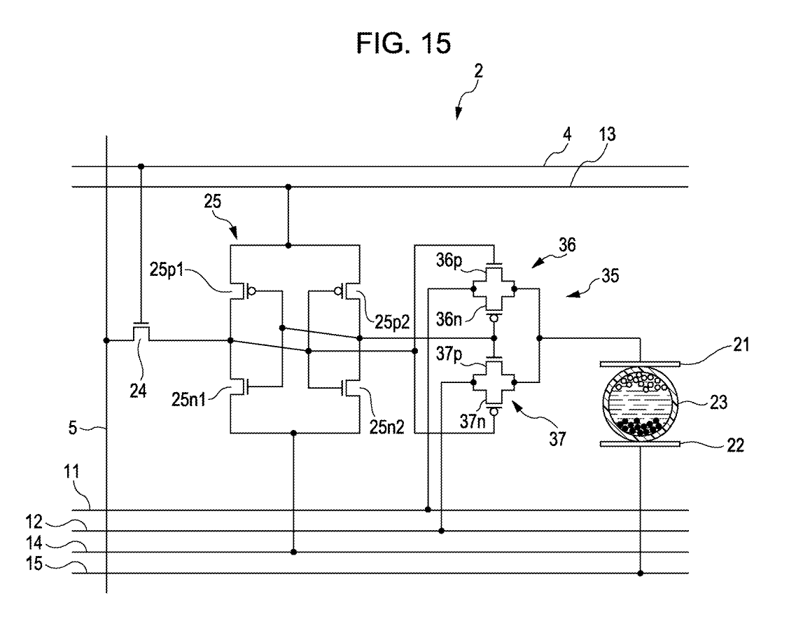

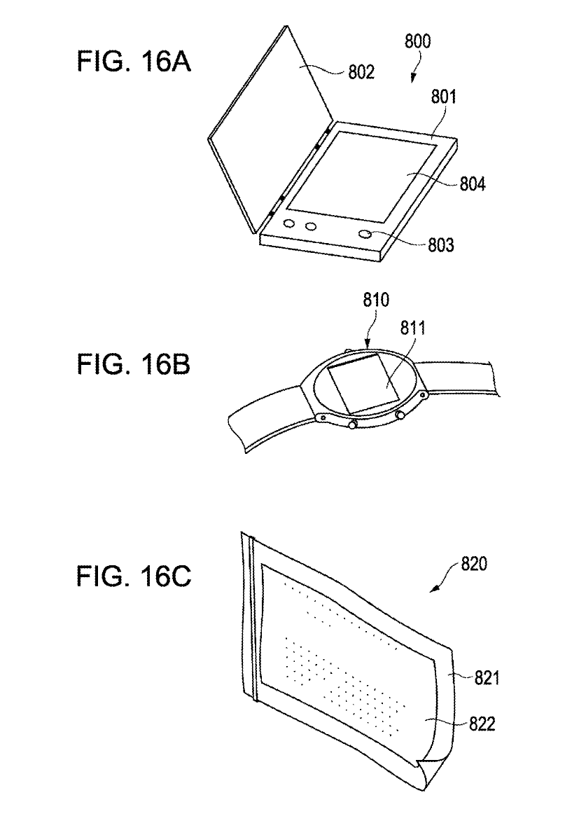

FIGS. 16A, 16B, and 16C are perspective views illustrating a specific example of an electronic device including an electrophoretic apparatus. FIG. 16A is a perspective view illustrating an electronic book as an example of an electronic device. The electronic book 800 includes a book-shaped frame 801, a (openable and closable) covering 802 rotatably mounted with respect to the frame 801, a manipulation unit 803, and a display unit 804 having an electrophoretic apparatus according to the embodiment of the invention. FIG. 16B is a perspective view illustrating a wristwatch as an example of the electronic device. The wristwatch 810 includes a display unit 811 configured with the electrophoretic apparatus according to the embodiment of the invention. FIG. 16C is a perspective view illustrating an electronic paper as an example of the electronic device. The electronic paper 820 includes a mainframe 821 configured with a rewritable sheet having texture and flexibility similar to paper and a display unit 822 configured with an electrophoretic apparatus according to the embodiment of the invention. The electronic device to which the electrophoretic apparatus can be applied is not limited thereto, but may include a wide variety of apparatuses which use visual color variation according to movement of the electrically-charged particles. In addition to the aforementioned devices, the invention may be applied to, for example, immovables such as a wall to which the electrophoretic film is attached, or movables such as vehicles, air vehicles, and ships.

The foregoing descriptions are not intended to limit the invention to the aforementioned embodiments, but various changes, modifications, or variations are possible. For example, while the embodiments of the invention have been described by exemplifying that the current detector 322 includes the detection resistor 325 and the potential difference detector 326, the detection resistor 325 and the potential difference detector 326 are not indispensable for the current detector 322, but other configurations may be employed if they can detect the current.

The entire disclosure of Japanese Patent Application Nos: 2009-034097, filed Feb. 17, 2009 and 2009-221215, filed Sep. 25, 2009 are expressly incorporated by reference herein.

What is claimed is:

1. An apparatus for driving an electrophoretic display unit, the apparatus comprising:
a current detector that detects a driving current supplied to or flowing out from the electrophoretic display unit and outputs a detection value corresponding to the driving current;
a conversion unit that converts the detection value into a corresponding temperature equivalent value; and
a driver that generates a driving control signal of the electrophoretic display unit based on the temperature equivalent value.

2. The apparatus according to claim 1,
wherein the driver comprises:
a driving voltage generator that generates a driving voltage by boosting a first voltage; and
a driving control signal generator that generates the driving control signal having a predetermined pulse width, a predetermined number of pulses, and a predetermined voltage based on the driving voltage,
wherein the driving control signal generator is configured to change at least one of the pulse width, the pulse number, and the voltage of the driving control signal.

3. The apparatus according to claim 1,
wherein the driver includes:
a driving voltage generator that generates a driving voltage by boosting a first voltage using a frequency signal; and
a driving control signal generator that generates the driving control signal having a predetermined pulse width, a predetermined number of pulses, and a predetermined voltage based on the driving voltage,
wherein the frequency of the frequency signal can change depending on the temperature equivalent value.

4. The apparatus according to claim 2,
wherein the current detector comprises:
a detection resistor disposed between the driving voltage generator and the electrophoretic display unit; and
a potential difference detector that detects a potential difference between both ends of the detection resistor and outputs, as a detection value, a driving current equivalent value based on a result of the detection.

5. The apparatus according to claim 1,
wherein the current detector comprises:
a detection resistor disposed between the electrophoretic display unit and a ground potential; and
a potential difference detector that detects a potential difference between both ends of the detection resistor and outputs, as a detection value, a driving current equivalent value based on a result of the detection.

6. The apparatus according to claim 1,
wherein the conversion unit includes:
an A/D converter that converts the detection value from an analog value into a digital value;
a cumulative average computing unit that outputs a cumulative average value obtained by adding and averaging the digital value for a time that is determined in advance; and
a conversion computing unit that converts the cumulative average value into a corresponding temperature equivalent value.

7. The apparatus according to claim 6, wherein the conversion computing unit converts the cumulative average value into the temperature equivalent value with reference to a lookup table which is previously prepared.

8. The apparatus according to claim 1, further comprising a display signal generator that generates a display signal for displaying an image on the electrophoretic display unit,
wherein the conversion unit converts the detection value while the electrophoretic display unit displays an image that is determined in advance.

9. The apparatus according to claim 1, wherein the conversion unit converts the detection value at an interval that is determined in advance based on change of a response speed of an electrophoretic display unit corresponding to change of an atmospheric temperature.

10. An electrophoretic apparatus comprising:
the apparatus for driving an electrophoretic display unit according to any one of claims 1 to 9; and
the electrophoretic display unit.

11. An electronic device comprising the electrophoretic apparatus according to claim 10.

12. A method of driving an electrophoretic display unit, the method comprising:
detecting a driving current supplied to or flowing out from the electrophoretic display unit and outputting a detection value corresponding to the driving current;
converting the detection value into a corresponding temperature equivalent value; and
generating a driving control signal of the electrophoretic display unit based on the temperature equivalent value.
